(19) United States
(12) Patent Application Publication
(10) Pub. No.: US 2005/0033473 A1
(43) Pub. Date: Feb. 10, 2005

(54) Item sorting system and method

(75) Inventors: Francis Mark Weiser, Monroe, CT (US); Mark Lee Richardson, Monrovia, CA (US)

Correspondence Address: SHOEMAKER AND MATTARE, LTD, 10 POST OFFICE ROAD - SUITE 110, SILVER SPRING, MD, 20910, US

(73) Assignee: Neopost Industrie SA, Bagneux (FR)

(21) Appl. No.: 10/759,214

(22) Filed: Jan. 20, 2004

Related U.S. Application Data
(60) Provisional application No. 60/441,877, filed on Jan. 22, 2003.

(51) Int. Cl. G06F 7/00; B07C 5/00; G06K 9/00

(52) U.S. Cl. 700/227; 209/584

(57) ABSTRACT

An item sorting system and method, the system comprising: at least one sender handling unit by which at least one sender applies imprints to items to be delivered to at least one receiver, wherein an imprint as applied to an item includes a sorting identifier; and at least one receiver sorting unit for sorting received items in accordance with a sorting protocol as determined from the sorting identifiers of the respective imprints, wherein each sorting protocol provides for the sorting of each of the received items into one of a plurality of groups such as to allow for different handling of the items of each of the respective groups.

This application claims priority from provisional U.S. Application No. 60/441,877, filed Jan. 22, 2003.

### FIELD OF THE INVENTION

The present invention relates to an item sorting system for and method of sorting items, in particular mail items, in accordance with predeterminable sorting criteria, such as in requiring different levels of security or urgency, as determined from sorting characteristics identified in imprints as applied to the items.

### BACKGROUND OF THE INVENTION

Currently, mail items, where delivered in a batch to a receiving facility, are sorted by name or department to allow for distribution to the intended recipients, but there is no provision to sort the mail items in accordance with sorting criteria as determined from sorting characteristics identified in imprints as applied to the items.

It is an aim of the present invention to provide an item sorting system and method which provides for the sorting of mail items in accordance with sorting criteria as determined from sorting characteristics identified in imprints as applied to the items.

### SUMMARY OF THE INVENTION

In one aspect the present invention provides an item sorting system, comprising: at least one sender handling unit by which at least one sender applies imprints to items to be delivered to at least one receiver, wherein an imprint as applied to an item includes a sorting identifier; and at least one receiver sorting unit for sorting received items in accordance with a sorting protocol as determined from the sorting identifiers of the respective imprints, wherein each sorting protocol provides for the sorting of each of the received items into one of a plurality of groups such as to allow for different handling of the items of each of the respective groups.

In one embodiment the sorting identifier comprises a sender identifier which identifies the sender of the respective item.

In one embodiment each sender is assigned a level of security and each of the groups has an assigned security level such that the items are sorted into the groups in accordance with the security level of the sender.

In another embodiment each sender is assigned a level of urgency and each of the groups has an assigned urgency level such that the items are sorted into the groups in accordance with the urgency level of the sender.

In another embodiment the sorting identifier comprises a security identifier assigning a level of security to the respective item and each of the groups has an assigned security level such that the items are sorted into the groups in accordance with the security level of each respective item.

In a further embodiment the sorting identifier comprises an urgency identifier assigning a level of urgency to the respective item and each of the groups has an assigned urgency level such that the items are sorted into the groups in accordance with the urgency level of each respective item.

In one embodiment an imprint as applied to an item includes an item characteristic identifier, and each receiver sorting unit is operative to determine a match of at least one characteristic of a received item to the at least one characteristic as assigned to the item characteristic identifier.

Preferably, the at least one characteristic comprises at least one physical characteristic, such as weight, size, color and reflectance.

Preferably, the at least one assigned characteristic is communicated to the receiver sorting unit independently of the item.

More preferably, the at least one assigned characteristic is electronically communicated to the receiver sorting unit.

Preferably, the imprints comprise barcodes.

Preferably, the items comprise mail items, such as letters and parcels.

In another aspect the present invention provides a method of sorting items, comprising the steps of: at least one sender applying imprints to items to be delivered to at least one receiver, wherein an imprint as applied to an item includes a sorting identifier; and the at least one receiver sorting received items in accordance with a sorting protocol as determined from the sorting identifiers of the respective imprints, wherein each sorting protocol provides for the sorting of each of the received items into one of a plurality of groups such as to allow for different handling of the items of each of the respective groups.

In one embodiment the sorting identifier comprises a sender identifier which identifies the sender of the respective item.

In one embodiment each sender is assigned a level of security and each of the groups has an assigned security level such that the items are sorted into the groups in accordance with the security level of the sender.

In another embodiment each sender is assigned a level of urgency and each of the groups has an assigned urgency level such that the items are sorted into the groups in accordance with the urgency level of the sender.

In another embodiment the sorting identifier comprises a security identifier assigning a level of security to the respective item and each of the groups has an assigned security level such that the items are sorted into the groups in accordance with the security level of each respective item.

In a further embodiment the sorting identifier comprises an urgency identifier assigning a level of urgency to the respective item and each of the groups has an assigned urgency level such that the items are sorted into the groups in accordance with the urgency level of each respective item.

In another embodiment an imprint as applied to an item includes an item characteristic identifier, and the method further comprises the step of: determining a match of at least one characteristic of a received item to the at least one characteristic as assigned to the item characteristic identifier.

Preferably, the at least one characteristic comprises at least one physical characteristic, such as weight, size, color and reflectance.

Preferably, the at least one assigned characteristic is communicated to the receiver independently of the item.

More preferably, the at least one assigned characteristic is electronically communicated to the receiver.

Preferably, the imprints comprise barcodes.

Preferably, the items comprise mail items, such as letters and parcels.

### BRIEF DESCRIPTION OF THE DRAWINGS

A preferred embodiment of the present invention will now be described hereinbelow by way of example only with reference to the accompanying drawings, in which:

FIG. 1 illustrates an item sorting system in accordance with a preferred embodiment of the present invention; and

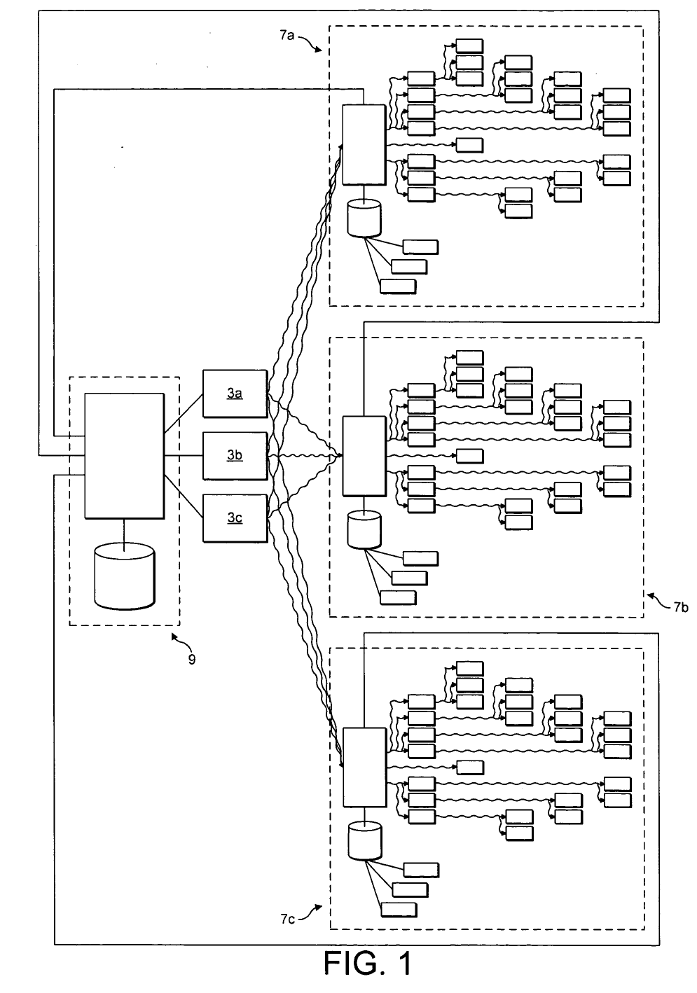

FIG. 2 illustrates one item sorting unit of the item sorting system of FIG. 1.

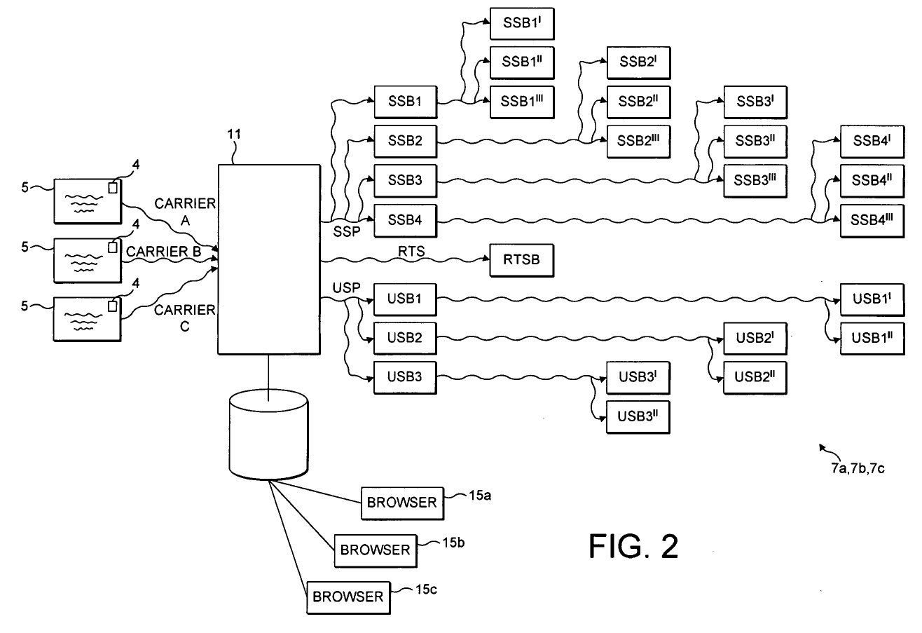

### DETAILED DESCRIPTION OF THE PREFERRED EMBODIMENT

The item sorting system comprises at least one, in this embodiment a plurality of sender handling units 3a, 3b, 3c by which respective senders apply imprints 4 to items 5 to be delivered to receivers, at least one, in this embodiment a plurality of receiver sorting units 7a, 7b, 7c for sorting items 5 as received from the senders, and a control center 9 for enabling operation of the item sorting system.

The sender handling units 3a, 3b, 3c provide for the printing of imprints 4 for items 5, where either printed directly or indirectly through labelling, which are to be delivered by one or more carriers, such as DHL, Fedex or the USPS.

In this embodiment the sender handling units 3a, 3b, 3c are each required to be registered with the control center 9 and the imprints 4 each include at least one of a sender identifier which is unique to the respective sender such that the sender of any item 5 can be identified from the imprint 4 thereon, a security identifier which identifies the level of security assigned to the respective item 5 and hence the security to be applied in handling the item 5, and an urgency identifier which identifies the level of urgency assigned to the respective item 5 and hence the level of urgency to be applied in handling the item 5. In one embodiment the sender identifiers can be the serial numbers of the respective sender handling units 3a, 3b, 3c.

Through such registration, the item sorting system inherently introduces security. Furthermore, through the inclusion of sender identifiers, the item sorting system allows for different levels of security, and hence trust, to be assigned to the senders; this level of security determining the handling of items 5 as received at the receiver sorting units 7a, 7b, 7c, as will be described in more detail hereinbelow.

In one embodiment the imprints 4 can include an item characteristic identifier, such as to provide for the identification of items 5 by at least one physical characteristic thereof, such as weight, size, color and reflectance. In a preferred embodiment the sender handling units 3a, 3b, 3c can each include a characteristic determiner for determining the at least one physical characteristic of the respective items 5, such as to allow for automated operation. In an alternative embodiment the at least one physical characteristic for any item 5 can be manually input by the respective sender. Through providing an item characteristic identifier, a cross-check can be effected to determine that the item 5 as received at a receiver sorting unit 7a, 7b, 7c has the same at least one physical characteristic as the item 5 as imprinted. In this embodiment the item characteristic identifier for any item 5 is provided to the respective receiver sorting unit 7a, 7b, 7c by way of an expected item announcement.

In this embodiment the imprints 4 comprise barcodes, such as one-dimensional or two-dimensional barcodes, which are machine readable. In an alternative embodiment the imprints 4 could be human-readable codes, such as alpha-numeric strings.

In this embodiment the imprints 4 are encoded, such as by digital signature or encryption.

In this embodiment the items 5 comprise mail items, such as letters or parcels.

The receiver sorting units 7a, 7b, 7c each provide for the sorting of items 5 in accordance with at least one sorting protocol. In this embodiment the receiver sorting units 7a, 7b, 7c provide for the sorting of items 5 in accordance with a first, security-sorting protocol SSP and a second, urgency-sorting protocol USP, with items 5 received from unregistered senders being returned to the respective senders. In one embodiment the receiver sorting units 7a, 7b, 7c can service a single site, but in other embodiments can service an organization located at more than one site.

In this embodiment the receiver sorting units 7a, 7b, 7c each include a return-to-sender bin RTSB to which items 5 not bearing a valid identifier are directed.

In this embodiment the receiver sorting units 7a, 7b, 7c each include a plurality of, here four security-sort bins SSB1, SSB2, SSB3, SSB4 corresponding to predetermined security levels, and each of the security-sort bins SSB1, SSB2, SSB3, SSB4 includes a plurality of, here three security-sort sub-bins SSB1′, SSB2′, SSB3′, SSB4′, SSB1″, SSB2″, SSB3″, SSB4″, SSB1′″, SSB2′″, SSB3′″, SSB4′″.

In this embodiment the security-sort bins SSB1, SSB2, SSB3, SSB4 represent four security levels, where the first-level security-sort bin SSB1 requires the items 5 to be security scanned, for example, by an X-ray machine, the second-level security-sort bin SSB2 is a closed bin which can only be opened by a designated person, the third-level security-sort bin SSB3 is a closed bin which can only be opened by one of a group of designated persons, and the fourth-level security sort bin SSB4 is an open bin, allowing for free delivery to the intended recipients.

In this embodiment each of the security-sort sub-bins SSB1′, SSB2′, SSB3′, SSB4′, SSB1″, SSB2″, SSB3″, SSB4″, SSB1′″, SSB2′″, SSB3′″, SSB4′″ corresponds to an urgency level, with the first-level security-sort sub-bin SSB1′, SSB2′, SSB3′, SSB4′ requiring immediate processing of the items 5 such as to allow for immediate delivery to the intended recipients, the second-level security-sort sub-bin SSB1″, SSB2″, SSB3″, SSB4″ requiring processing of the items 5 within a predetermined time period, for example, two hours, such as to allow for delivery to the intended recipients within that time period, and the third-level security-sort sub-bin SSB1′″, SSB2′″, SSB3′″, SSB4′″ requiring processing of the items 5 in a normal, non-expedited time frame.

In this embodiment the receiver sorting units 7a, 7b, 7c each include a plurality of, here three urgency-sort bins USB1, USB2, USB3 corresponding to predetermined urgency levels in distribution, and each of the urgency-sort bins USB1, USB2, USB3 includes a plurality of, here two urgency-sort sub-bins USB1′, USB2′, USB3′, USB1″, USB2″, USB3″.

In this embodiment the urgency-sort bins USB1, USB2, USB3 represent three urgency levels, where the first-level urgency-sort bin USB1 requires immediate processing of the items 5 such as to allow for immediate delivery to the intended recipients, the second-level urgency-sort bin USB2 requires processing of the items 5 within a predetermined time period, for example, two hours, such as to allow for delivery to the intended recipients within that time period, and the third-level urgency-sort bin USB3 requires processing of the items 5 in a normal, non-expedited time frame.

In this embodiment each of the urgency-sort sub-bins USB1′, USB2′, USB3′, USB1″, USB2″, USB3″ corresponds to a delivery mode, with the first-level urgency-sort sub-bin USB1′, USB2′, USB3′ requiring signature on delivery of the items 5, and the second-level urgency-sort sub-bin USB1″, USB2″, USB3″ requiring normal, unsigned delivery of the items 5.

In this embodiment the receiver sorting units 7a, 7b, 7c each comprise a sorter 11 for providing for the sorting of the received items 5 in accordance with the security-sorting protocol SSP and the urgency-sorting protocol USP.

In this embodiment the sorter 11 includes a reader for automated reading of the imprints 4 on items 5, where possible, and a hand scanner for reading the imprints 4 on items 5 which cannot be read by the reader. In this embodiment the sorter 11 also includes provision for the manual input of imprints 4, where in human-readable form. In alternative embodiments the sorter 11 could be configured to provide only for hand scanning or manual input of the imprints 4.

From each imprint 4, the sorter 11 determines, where included, the sender identifier, the security identifier, the urgency identifier and the item characteristic identifier.

In this embodiment the receiver sorting units 7a, 7b, 7c each include a characteristic determiner for determining at least one physical characteristic for each item 5, such as weight, size, color and reflectance. In one embodiment the characteristic determiner is such as to provide for automated operation. In an alternative embodiment the at least one physical characteristic for any item 5 can be manually input by the receiver.

Where the imprint 4 does not include any valid identifier, in this embodiment the item 5 to which the imprint 4 is applied is directed to the return to sender bin RTSB and subsequently returned to the sender.

Where the imprint 4 includes only a sender identifier, the item 5 to which the imprint 4 is applied is sorted in accordance with the sorting profile assigned to that sender.

Where the sorting profile defines a security sort at a predetermined security level, the item 5 is directed to the security-sort bin SSB1, SSB2, SSB3, SSB4 corresponding to the predetermined security level. Where the sorting profile further defines an urgency level, the item 5 is directed to the one of the security-sort sub-bins SSB1′, SSB2′, SSB3′, SSB4′, SSB1″, SSB2″, SSB3″, SSB4″, SSB1′″, SSB2′″, SSB3′″, SSB4′″ corresponding to the urgency level.

Where the sorting profile defines an urgency sort at a predetermined urgency level, the item 5 is directed to the urgency-sort bin USB1, USB2, USB3 corresponding to the predetermined urgency level. Where the sorting profile further defines a delivery level, the item 5 is directed to the one of the urgency-sort sub-bins USB1′, USB2′, USB3′, USB1″, USB2″, USB3″ corresponding to the delivery level.

Where the imprint 4 includes a security identifier, the item 5 to which the imprint 4 is applied is sorted in accordance with the security sort protocol SSP at the assigned security level, with the item 5 being directed to the security-sort bin SSB1, SSB2, SSB3, SSB4 corresponding to the predetermined security level. Where the security identifier further defines an urgency level, the item 5 is directed to the one of the security-sort sub-bins SSB1′, SSB2′, SSB3′, SSB4′, SSB1″, SSB2″, SSB3″, SSB4″, SSB1′″, SSB2′″, SSB3′″, SSB4′″ corresponding to the assigned urgency level.

Where the imprint 4 includes an urgency identifier, the item 5 to which the imprint 4 is applied is sorted in accordance with the urgency sort protocol USP at the assigned urgency level, with the item 5 being directed to the urgency-sort bin USB1, USB2, USB3 corresponding to the predetermined urgency level. Where the urgency identifier further defines a delivery level, the item 5 is directed to the one of the urgency-sort sub-bins USB1′, USB2′, USB3′, USB1″, USB2″, USB3″ corresponding to the assigned urgency level.

Where the imprint 4 includes an item characteristic identifier, the at least one physical characteristic of the received item 5 to which the imprint 4 is applied is cross-checked against the expected at least one physical characteristic of the item 5 as provided to the receiver sorting unit 7a, 7b, 7c by way of an expected item announcement. Where a match is determined, the item 5 is further processed, but where a match is not determined, that is, where a physical characteristic of the received item 5 differs from that expected for the item 5, the item 5 is, in this embodiment, directed to the first-level security-sort sub-bin SSB1′ for immediate analysis.

In cross-checking physical characteristics of items 5 as received to those as imprinted, it is possible to identify items 5 which have been subject to tampering. For example, tampering can occur by way of removing or introducing material from a package, leading to a change in weight, or the package can be replaced, which packaging could be of different size, color or reflectance.

The item sorting units 7a, 7b, 7c each further comprise at least one, in this embodiment a plurality of browsers 15a, 15b, 15c for enabling authorised recipients to determine whether an expected item 5 has been received. For example, where the item 5 is a letter enclosing a cheque and the cheque is required by a deadline, the recipient can query the status of that item 5. In one embodiment the browsers 15a, 15b, 15c are enabled personal computers (PCs), which typically communicate by a local area network (LAN) or virtual private network (VPN).

Finally, it will be understood that the present invention has been described in its preferred embodiment and can be modified in many different ways without departing from the scope of the invention as defined by the appended claims.

In this embodiment the item sorting system is embodied for illustrative purposes as comprising three sender handling units 3a, 3b, 3c and three receiver sorting units 7a, 7b, 7c, but it will be understood that the system can comprise and number of sender handling units 3a, 3b, 3c and any number of receiver sorting units 7a, 7b, 7c.

1. An item sorting system, comprising:
at least one sender handling unit by which at least one sender applies imprints to items to be delivered to at least one receiver, wherein an imprint as applied to an item includes a sorting identifier; and
at least one receiver sorting unit for sorting received items in accordance with a sorting protocol as determined from the sorting identifiers of the respective imprints, wherein each sorting protocol provides for the sorting of each of the received items into one of a plurality of groups such as to allow for different handling of the items of each of the respective groups.

2. The system of claim 1, wherein the sorting identifier comprises a sender identifier which identifies the sender of the respective item.

3. The system of claim 2, wherein each sender is assigned a level of security and each of the groups has an assigned security level such that the items are sorted into the groups in accordance with the security level of the sender.

4. The system of claim 2, wherein each sender is assigned a level of urgency and each of the groups has an assigned urgency level such that the items are sorted into the groups in accordance with the urgency level of the sender.

5. The system of claim 1, wherein the sorting identifier comprises a security identifier assigning a level of security to the respective item and each of the groups has an assigned security level such that the items are sorted into the groups in accordance with the security level of each respective item.

6. The system of claim 1, wherein the sorting identifier comprises an urgency identifier assigning a level of urgency to the respective item and each of the groups has an assigned urgency level such that the items are sorted into the groups in accordance with the urgency level of each respective item.

7. The system of claim 1, wherein an imprint as applied to an item includes an item characteristic identifier, and each receiver sorting unit is operative to determine a match of at least one characteristic of a received item to the at least one characteristic as assigned to the item characteristic identifier.

8. The system of claim 7, wherein the at least one characteristic comprises at least one physical characteristic, such as weight, size, color and reflectance.

9. The system of claim 7, wherein the at least one assigned characteristic is communicated to the receiver sorting unit independently of the item.

10. The system of claim 9, wherein the at least one assigned characteristic is electronically communicated to the receiver sorting unit.

11. The system of claim 1, wherein the imprints comprise barcodes.

12. The system of claim 1, wherein the items comprise mail items, such as letters and parcels.

13. A method of sorting items, comprising the steps of:
at least one sender applying imprints to items to be delivered to at least one receiver, wherein an imprint as applied to an item includes a sorting identifier; and
the at least one receiver sorting received items in accordance with a sorting protocol as determined from the sorting identifiers of the respective imprints, wherein each sorting protocol provides for the sorting of each of the received items into one of a plurality of groups such as to allow for different handling of the items of each of the respective groups.

14. The method of claim 13, wherein the sorting identifier comprises a sender identifier which identifies the sender of the respective item.

15. The method of claim 14, wherein each sender is assigned a level of security and each of the groups has an assigned security level such that the items are sorted into the groups in accordance with the security level of the sender.

16. The method of claim 14, wherein each sender is assigned a level of urgency and each of the groups has an assigned urgency level such that the items are sorted into the groups in accordance with the urgency level of the sender.

17. The method of claim 13, wherein the sorting identifier comprises a security identifier assigning a level of security to the respective item and each of the groups has an assigned security level such that the items are sorted into the groups in accordance with the security level of each respective item.

18. The method of claim 13, wherein the sorting identifier comprises an urgency identifier assigning a level of urgency to the respective item and each of the groups has an assigned urgency level such that the items are sorted into the groups in accordance with the urgency level of each respective item.

19. The method of claim 13, wherein an imprint as applied to an item includes an item characteristic identifier, and further comprising the step of:
determining a match of at least one characteristic of a received item to the at least one characteristic as assigned to the item characteristic identifier.

20. The method of claim 19, wherein the at least one characteristic comprises at least one physical characteristic, such as weight, size, color and reflectance.

21. The method of claim 19, wherein the at least one assigned characteristic is communicated to the receiver independently of the item.

22. The method of claim 21, wherein the at least one assigned characteristic is electronically communicated to the receiver.

23. The method of claim 13, wherein the imprints comprise barcodes.

24. The method of claim 13, wherein the items comprise mail items, such as letters and parcels.
